(19) United States
(12) Patent Application Publication
(10) Pub. No.: US 2018/0332532 A1
(43) Pub. Date: Nov. 15, 2018

(54) Power Consumption Enhancements for Less Mobile UEs

(71) Applicant: MEDIATEK INC., Hsinchu (TW)

(72) Inventors: Per Johan Mikael Johansson, Kungsangen (SE); Li-Chuan Tseng, Hsinchu (TW)

(21) Appl. No.: 15/977,096

(22) Filed: May 11, 2018

Related U.S. Application Data
(60) Provisional application No. 62/505,780, filed on May 12, 2017.

(51) Int. Cl. H04W 52/02; H04W 24/10; H04W 24/02; H04W 36/32; H04W 76/28; H04W 68/02; H04W 76/27; H04W 76/30

(52) U.S. Cl. CPC H04W 52/0209; H04W 24/10; H04W 24/02; H04W 76/30; H04W 76/28; H04W 68/02; H04W 76/27; H04W 36/32

(57) ABSTRACT

Novel UE operation modes are proposed to improve the power consumption for potentially less mobile UEs, both for stationary UEs, almost stationary UEs, and limited mobility UEs by optimizing neighbor cell measurements and/or by optimizing UE wakeup sequence. Optimized neighbor cell measurements mean that the procedure can be done less frequently or not at all during certain conditions. Optimized wakeup sequence (with less wakeup time) mainly affect paging performance via UE implementations. It is an object of the current invention to allow UE to be aware of its mobility states, via either explicit configuration or self-estimation, and adjust its wakeup and measurement behaviors accordingly. Also, some UEs are allowed to switch among different mobility states, while other UEs are fixed in a given mobility state.

### CROSS REFERENCE TO RELATED APPLICATION

This application claims priority under 35 U.S.C. § 119 from U.S. Provisional Application No. 62/505,780, entitled “Power Consumption Enhancements for Less Mobile UEs,” filed on May 12, 2017, the subject matter of which is incorporated herein by reference.

### TECHNICAL FIELD

The disclosed embodiments relate generally to wireless communication systems, and, more particularly, to user equipment (UE) mobility states and power consumption enhancements.

### BACKGROUND

3GPP Long-Term Evolution (LTE) systems offer high peak data rates, low latency, improved system capacity, and low operating cost resulting from simple network architecture. A 3GPP LTE system also provides seamless integration to older wireless network, such as GSM, CDMA and Universal Mobile Telecommunication System (UMTS). Enhancements to LTE systems are considered so that they can meet or exceed IMA-Advanced fourth generation (4G) standard. One of the key enhancements is to support bandwidth up to 100 MHz and be backwards compatible with the existing wireless network system. In LTE/LTE-A systems, an evolved universal terrestrial radio access network (E-UTRAN) includes a plurality of evolved Node-Bs (eNBs) communicating with a plurality of mobile stations, referred as user equipments (UEs).

Typically, each UE needs to periodically measure the received signal quality of the serving cell and neighbor cells and reports the measurement result to its serving eNB for potential handover or cell reselection. The measurements may drain the UE battery power. In order to keep UE battery consumption low, the UE needs to toggle between sleeping and awake states. Preferably it should be possible for UEs in RRC Connected mode to apply similar sleep/awake performance as in Idle mode, to have similar battery consumption as in Idle mode. To save power, Discontinuous Reception (DRX) needs to be used in Connected mode, with short awake times and long sleep cycles. With DRX extension, UEs can be configured with even longer RRC Connected mode DRX cycle.

Despite the benefit of power saving under DRX and DRX extension, UE power consumption from functions for UE mobility can still be significant, even in RRC Idle mode. Power consumption comes from, e.g., searching, detecting, and measuring neighbor cells, waking up to do cell reselection, to keep system information knowledge up to date, and to receive paging when the UE is camping on a cell. For 3GPP and other cellular systems, the requirements for such procedure has generally been related to DRX operation. The same UE power consumption issue exists in next generation 5G systems.

There is opportunity to improve 3GPP UE behaviors to take into account other factors beyond DRX operation. For example, the above operation can be performed less frequently, or the wakeup procedure can be optimized and shortened, so as to reduce power consumption for UEs in particular situations. The particular identified situations include: 1) stationary or almost stationary UEs—where very aggressive optimization can be done, though needs to be done carefully to ensure correct system operation; and 2) UEs that are indoor and covered by outdoor coverage, e.g., devices served deep indoor—where the required UE activity limitation cannot be determined by a serving cell measurement.

It is thus desirable for UEs for be aware of its mobility states, via either explicit configuration or self-estimation, and adjust its wakeup and measurement behaviors for power consumption enhancements.

### SUMMARY

Novel UE operation modes are proposed to improve the power consumption for potentially less mobile UEs, both for stationary UEs, almost stationary UEs, and limited mobility UEs by optimizing neighbor cell measurements and/or by optimizing UE wakeup sequence. Optimized neighbor cell measurements mean that the procedure can be done less frequently or not at all during certain conditions. Optimized wakeup sequence (with less wakeup time) mainly affect paging performance via UE implementations. It is an object of the current invention to allow UE to be aware of its mobility states, via either explicit configuration or self-estimation, and adjust its wakeup and measurement behaviors accordingly. Also, some UEs are allowed to switch among different mobility states, while other UEs are fixed in a given mobility state.

In one embodiment, a UE detects that it is in a normal mobility state and camping on a serving cell of a wireless communication system. The UE performs neighbor cell measurements with a predefined periodicity when the UE stays in the normal mobility state. The UE detects and switches the UE to a stationary mobility state when the UE has been camping on the same serving cell for a predefined duration and a serving cell signal strength variation is less than a predefined threshold for the predefine duration. The UE stops performing neighbor cell measurements with the predefined periodicity when the UE stays in the stationary mobility state and when the UE satisfies a list of criteria.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates mobility management with power consumption enhancement of a user equipment (UE) applying multiple mobility states in a 4G/5G network in accordance with one novel aspect.

FIG. 2 is a simplified block diagram of a UE for mobility management with power consumption enhancements in accordance with one novel aspect.

FIG. 3 illustrates one embodiment of UE mobility state transition when operating in dynamic mode for switching among different mobility states.

FIG. 4 illustrates a message flow between a UE and a network for mobility management with power consumption enhancements in accordance with one novel aspect.

FIG. 5 is a flow chart of a method mobility management with UE power consumption enhancements in a LTE network in accordance with one novel aspect.

### DETAILED DESCRIPTION

Reference will now be made in detail to some embodiments of the invention, examples of which are illustrated in the accompanying drawings.

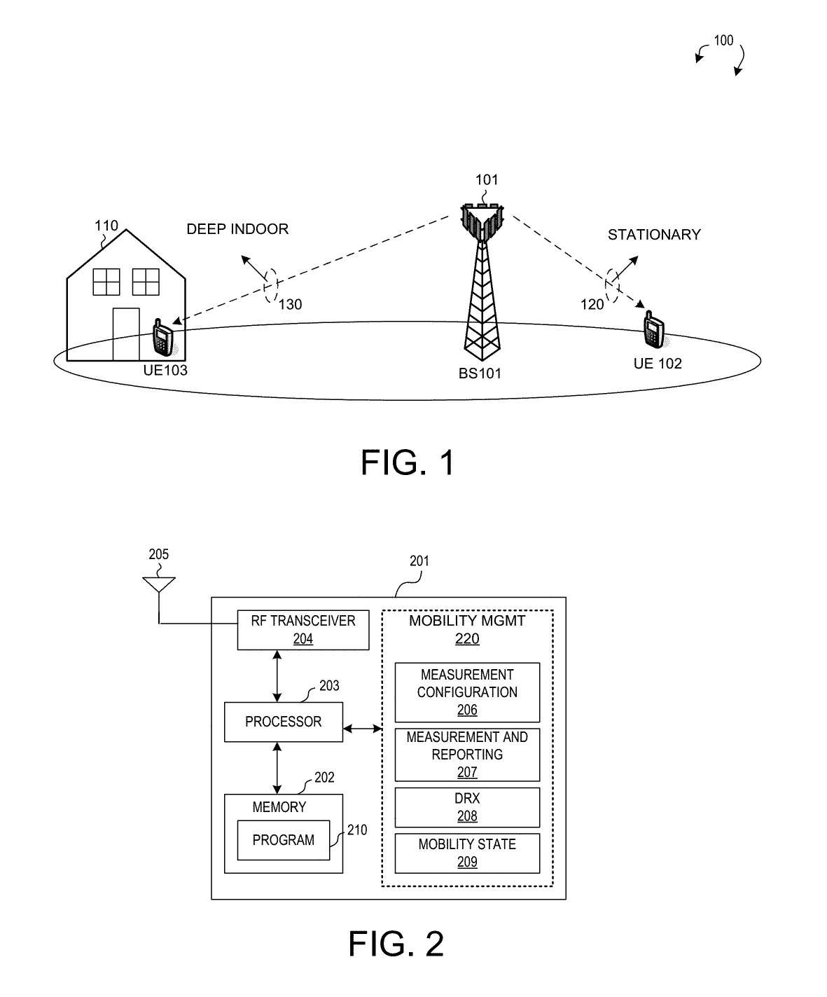

FIG. 1 illustrates mobility management with power consumption enhancement of a user equipment (UE) applying multiple mobility states in a 4G/5G network in accordance with one novel aspect. In LTE/LTE-A systems, an evolved universal terrestrial radio access network (E-UTRAN) includes a plurality of base stations, referred as evolved Node-Bs (eNBs) (e.g., BS 101) communicating with a plurality of mobile stations, referred as user equipments (UEs) (e.g., UE 102 and UE 103). In next generation 5G systems, base station eNB is referred to as gNB. Typically, each UE needs to periodically measure the received signal quality of the serving cell and neighbor cells and reports the measurement result to its serving BS for potential handover or cell reselection. The measurements may significantly drain the UE battery power. In order to keep UE battery consumption low, UE needs to toggle between sleeping and awake states. Preferably it should be possible for UEs in RRC Connected mode to apply similar sleep/awake performance as in Idle mode, to have similar battery consumption as in Idle mode. To save power, Discontinuous Reception (DRX) needs to be used in RRC Connected mode, with short awake times and long sleep cycles. With DRX extension, UEs can be configured with even longer Connected mode DRX cycle for additional power saving opportunities.

Legacy art includes the Stop-IntraSearch and Stop-InterSearch mechanisms that intend to limit UE activities whenever the UE is not at the cell edge as determined by a serving cell signal measurement. In RRC Connected mode, a UE is not required to perform neighbor cell measurements if the serving cell quality is above the s-Measure threshold. Similarly, an RRC Idle UE may also skip neighbor cell measurements if the serving cell quality is above the Stop-InterSearch threshold. However, this mechanism is not deemed sufficient for modern Machine-to-Machine (M2M) scenarios with aggressive battery life requirements. For example, UE 103 may be an M2M device that is served deep indoor, where the required UE activity limitation cannot be determined by a neighbor cell measurement. In another example, UE 102 may be stationary or mostly stationary, for which very aggressive battery saving optimization can be done, though needs to be done carefully to ensure correct system operation.

In summary, a problem with prior art is that for UEs that can hardly find a proper neighbor cell, neighbor cell measurement may be meaningless and simply consuming power. In accordance with one novel aspect, based on configuration or self-estimation, UE can determine its mobility state. For example, UE 102 and UE 103 can determine their mobility states by measuring the received signal strength of radio signals 120 and 130. Possible mobility states include but not limited to the following: normal (mobile), limited mobility, and stationary. Based on configuration, UE can operate in a fixed mobility state or dynamically switch among different mobility states. Possible operation modes include but not limited to normal (mobile), configured stationary, and dynamic (UE switching among different mobility states).

FIG. 2 is a simplified block diagram of a UE for mobility management with power consumption enhancements in accordance with one novel aspect. UE 201 has memory 202, a processor 203, and radio frequency (RF) transceiver module 206. RF transceiver 204 is coupled with antenna 205, receives RF signals from antenna 207, converts them to baseband signals, and sends them to processor 203. RF transceiver 204 also converts received baseband signals from the processor 203, converts them to RF signals, and sends out to antenna 205. Processor 203 processes the received baseband signals and invokes different functional modules to perform features in UE 201. Memory 202 stores data and program instructions 210 to be executed by the processor to control the operations of UE 201. Suitable processors include, by way of example, a special purpose processor, a digital signal processor (DSP), a plurality of microprocessors, one or more microprocessors associated with a DSP core, a controller, a microcontroller, Application specific integrated circuits (ASICs), Field programmable gate array (FPGAs) circuits, and other type of integrated circuit (IC), and/or state machine. A processor in associated with software may be used to implement and configure features of UE 201.

UE 201 also includes multiple function modules and circuits that carry out different tasks in accordance with embodiments of the current invention. The function modules and circuits may be implemented and configured by hardware, firmware, software, and combinations of the above. In one example, mobility management module 220 further comprises several functional modules and circuits. Measurement configuration module 206 that receives measurement and reporting configuration from the network and configures its measurement interval and reporting criteria accordingly. Measurement and reporting module 207 performs various L1/L2 measurements and L3 filtering for reference signal received power and/or reference signal received quality (RSRP/RSRQ) over serving and neighboring cells, and then determines whether any measurement event is triggered for measurement reporting. Discontinuous Reception (DRX) module 208 configures UE 201 for DRX operation with corresponding DRX parameters received from the network. Mobility state module 209 determines UE mobility states by configuration or self-estimation such that UE 201 can operate in corresponding operation modes for power consumption enhancements.

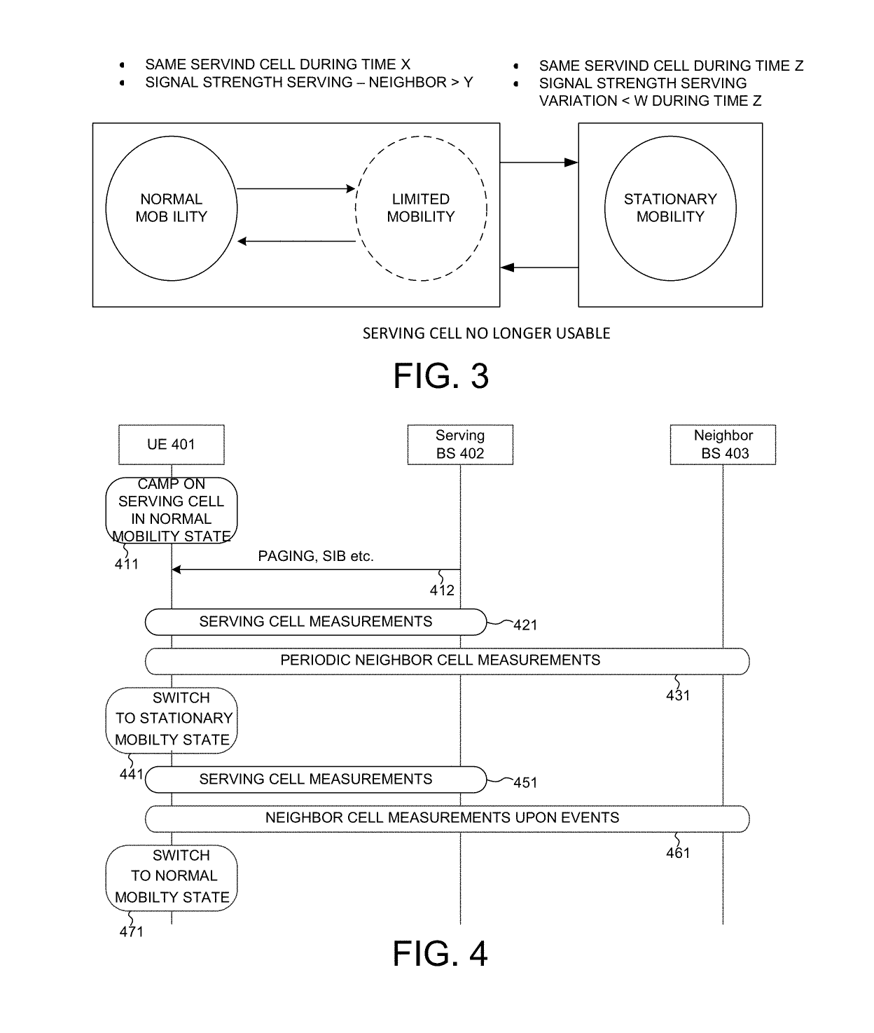

FIG. 3 illustrates one embodiment of UE mobility state transition when operating in dynamic mode for switching among different mobility states. Possible mobility states include but not limited to the following: normal (mobile), limited mobility, and stationary. Based on configuration, UE can operate in a fixed mobility state or dynamically switch among different mobility states. Possible operation modes include but not limited to normal (mobile), configured stationary, and dynamic (UE switching among different mobility states).

In normal (mobile) mobility state, the UE fulfills detection and measurement requirements for mobility. In general, the UE performs normal periodic serving cell and neighbor cell measurements. In limited mobility state, the UE does not fully fulfill detection and measurement requirements for mobility. The power consumption is lower. In one example, in extended DRX (eDRX), the UE would limit pre-wakeup, only do cell reselection at a first pre-wakeup, potentially do cell reselection during Paging Time Window (PTW). With eDRX, after a long sleep, the UE would monitor several paging occasions (POs) in a PTW, where the POs appears with normal DRX cycle. This is to avoid the situation that a UE misses the PO and has to wait for a very long interval for next PO. In another example, the UE fulfills no or very relaxed inter-frequency or inter-RAT requirements. In stationary mobility state, the UE does not fulfill detection and measurement requirements for mobility at all. The power consumption is even lower. For example, the UE would not wake up to do cell reselection or to account for system information (SI) re-check before paging. Before each PO, UE needs to pre-wakeup for synchronization. Since the receiver is on, UE can also perform neighbor cell measurement and cell reselection. But for UE in limited or stationary mobility state, UE may reduce or stop neighbor cell measurement to save power. The UE pre-wakeup time before POs would mainly depend on UE internal oscillator accuracy.

Considering different applications, the UE could be configured in several modes of operation. In configured normal mode, the UE would assume the normal mobility state unless other behavior is explicitly enabled. In configured stationary mode, the UE is configured to stay in the stationary mobility state. In dynamic mode, the UE could perform dynamic switching between the different mobility states. A UE configured as dynamic operation mode can estimate its current mobility state and switch among different mobility states.

In the example of FIG. 3, UE is first in normal mobility state, and switches to limited mobility state when UE has been camping on the same serving cell for a predefined duration X, and the signal strength of the serving cell is better than the signal strength of the neighbor cells by a predefined amount Y or no neighbor cell is detected during the predefined duration X. In limited mobility state, UE applies relaxed or less frequent inter-frequency and/or inter-RAT measurements. The UE further limits measurements and mobility operations during paging pre-wakeup, e.g., the UE in DRX only pre-wakeup once, and if the serving cell is still suitable, the UE next time just wakes up in time for paging. Later, the UE switches to stationary mobility state when the UE has been camping on the same serving cell during a predefined duration Z, and the signal strength variation of the serving cell is less than a predefined amount W during the predefined duration Z. In stationary mobility state, the UE switches back to normal mobility state if the serving cell is no longer usable.

Note that it is possible that the UE switches to the stationary mobility state from the normal mobility state directly, e.g., when the UE has been camping on the same serving cell for the predefined duration Z and a serving cell signal strength variation is less than the value W for the duration Z. Further note that the limited mobility state can be an optional UE-implemented internal mobility state. The normal mobility state and the limited mobility state together can be considered as a single mobility state with normal mobility measurement behavior, while stationary mobility state is another single mobility state with relaxed mobility measurement behavior. In addition, the terminology defined such as “stationary”, “limited mobility”, “normal”, is intended to be general, and can be used interchangingly with other equivalent or almost equivalent language.

FIG. 4 illustrates a message flow between a UE and a network for mobility management with power consumption enhancements in accordance with one novel aspect. In step 411, UE 401 camps on a serving cell served by a serving base station BS 402. In step 412, UE 401 wakes up to do cell reselection, to keep SI knowledge up to date, and to receive paging from BS 402 in Idle mode. UE 401 by default is in a normal mobility state and fulfills detection and measurement requirements. UE 401 may also receive pre-configuration from BS 402 on measurement parameters, mobility states, and operation modes. In step 421, UE 401 performs serving cell measurements with configured periodicity. In step 431, UE 401 performs neighbor cell measurements with configured periodicity. Note that legacy UE activity relaxation can be regarded as being included for the normal mobility state, such as non-activity during DRX or extended-DRX sleep, non-activity when serving cell signal strength is higher than a predefined cell search threshold, etc.

In step 441, UE 401 detects that it is stationary or almost stationary and switches to stationary mobility state. For example, UE 401 detects that it has been camping on the same serving cell during a predefined duration Z, and the signal strength variation of the serving cell is less than a predefined amount W during the predefined duration Z or UE 401 cannot detect any neighbor cell for cell reselection. In stationary mobility state, UE 401 does not fulfill detection and measurement requirements for mobility at all. In step 451, UE 401 performs serving cell measurements based on predefined periodicity, e.g., the DRX cycle. Typically, if the serving cell is below certain threshold, UE measures neighbor cell. However, in stationary mobility state, UE 401 does not perform normal periodic neighbor cell measurements even the serving cell is below certain threshold. This is because since UE 401 is not moving, measuring neighbor cell does not help.

In step 461, UE 401 performs neighbor cell measurements and cell reselection or cell selection at certain events. The event may comprise at least one of the following: an indication in a paging message, an indication in a System Information Broadcast message, an indication in a RRC Connected Release message, UE power on, or the serving cell is no longer suitable or cannot be detected. In one example, UE 401 in stationary mobility state performs cell reselection to support network changes in the following ways: recurring but very slow (e.g., find a new cell every 24 hour); recurring and with configured longer periodicity; network triggered cell reselection, e.g., if the network indicates that SIB3/SIB5 are changed, e.g., particular paging or SIB indication. In step 471, UE switches back to normal mobility state when the serving cell is no longer usable.

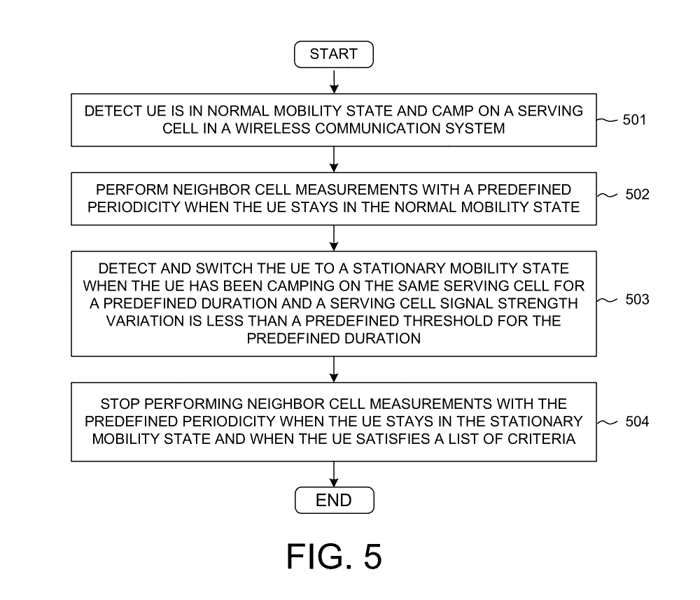

FIG. 5 is a flow chart of a method mobility management with UE power consumption enhancements in a LTE network in accordance with one novel aspect. In step 501, a UE detects that it is in a normal mobility state and camping on a serving cell of a wireless communication system. In step 502, the UE performs neighbor cell measurements with a predefined periodicity when the UE stays in the normal mobility state. In step 503, the UE detects and thereby switches the UE to a stationary mobility state when the UE has been camping on the same serving cell for a predefined duration and a serving cell signal strength variation is less than a predefined threshold for the predefine duration. In step 504, the UE stops performing neighbor cell measurements with the predefined periodicity when the UE stays in the stationary mobility state and when the UE satisfies a list of criteria.

Although the present invention is described above in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method, comprising:
detecting that a user equipment (UE) is in a normal mobility state and camping on a serving cell of a base station in a wireless communication system;
performing neighbor cell measurements with a predefined periodicity when the UE stays in the normal mobility state;
detecting and thereby switching to a stationary mobility state from the normal mobility state when the UE has been camping on the same serving cell for a predefined duration and a serving cell signal strength variation is less than a predefined threshold for the predefine duration; and
stop performing neighbor cell measurements with the predefined periodicity when the UE stays in the stationary mobility state and when the UE satisfies a list of criteria.

2. The method of claim 1, wherein the UE stays in the stationary mobility state when the UE cannot detect any neighbor cell.

3. The method of claim 2, wherein the UE wakes up at paging occasions without prior pre-wakeup to do cell reselection or synchronize to a new cell.

4. The method of claim 2, wherein the UE performs neighbor cell measurements when the UE receives an indication in a paging message, a broadcast message, or an RRC connection release message.

5. The method of claim 2, wherein the list of criteria comprises UE performing neighbor cell measurements with a periodicity of at least 24 hours or with a configured periodicity.

6. The method of claim 1, wherein the UE switches to an internal limited mobility state from the normal mobility state when the UE has been camping on the same serving cell for a duration X and a serving cell signal strength is higher than any neighbor cell signal strength by a value Y for the duration X.

7. The method of claim 6, wherein the UE in the internal limited mobility state performs relaxed neighbor cell measurements with a longer periodicity than the predefined periodicity.

8. The method of claim 6, wherein the UE switched back to the normal mobility state from the internal limited mobility state when the serving cell cannot be used.

9. The method of claim 1, wherein the UE switches back to the normal mobility state from the stationary mobility state when the serving cell cannot be used.

10. The method of claim 1, wherein the UE receives configuration from the base station to stay in the stationary mobility state.

11. A user equipment (UE), comprising:
a radio frequency (RF) receiver that receives radio signals from a base station and detects that the UE is in a normal mobility state and camping on a serving cell of a wireless communication system;
a measurement circuit that performs neighbor cell measurements with a predefined periodicity when the UE stays in the normal mobility state; and
a mobility state circuit that detects and switches the UE to a stationary mobility state when the UE has been camping on the same serving cell for a predefined duration and a serving cell signal strength variation is less than a predefined threshold for the predefine duration, wherein the UE stops performing neighbor cell measurements with the predefined periodicity when the UE stays in the stationary mobility state and when the UE satisfies a list of criteria.

12. The UE of claim 11, wherein the UE stays in the stationary mobility state when the UE cannot detect any neighbor cell.

13. The UE of claim 12, wherein the UE wakes up at paging occasions without prior pre-wakeup to do cell reselection or synchronize to a new cell.

14. The UE of claim 12, wherein the UE performs neighbor cell measurements when the UE receives an indication in a paging message, a broadcast message, or an RRC connection release message.

15. The UE of claim 12, wherein the list of criteria comprises UE performing neighbor cell measurements with a periodicity of at least 24 hours or with a configured periodicity.

16. The UE of claim 11, wherein the UE switches to an internal limited mobility state from the normal mobility state when the UE has been camping on the same serving cell for a duration X and a serving cell signal strength is higher than any neighbor cell signal strength by a value Y for the duration X.

17. The UE of claim 16, wherein the UE in the internal limited mobility state performs relaxed neighbor cell measurements with a longer periodicity than the predefined periodicity.

18. The UE of claim 16, wherein the UE switched back to the normal mobility state from the internal limited mobility state when the serving cell cannot be used.

19. The UE of claim 11, wherein the UE switches back to the normal mobility state from the stationary mobility state when the serving cell cannot be used.

20. The UE of claim 11, wherein the UE receives configuration from the base station to stay in the stationary mobility state.
